(19) United States
(12) Patent Application Publication
(10) Pub. No.: US 2024/0151651 A1
(43) Pub. Date: May 9, 2024

(54) UV INSPECTION FOR IDENTIFYING INADEQUATE COATING ON A BEVERAGE CAN BOTTOM

(71) Applicant: KRONES AG, Neutraubling (DE)

(72) Inventors: Erwin KNIELING, Neutraubling (DE); Michael DOSTALEK, Neutraubling (DE)

(21) Appl. No.: 18/388,094

(22) Filed: Nov. 8, 2023

(30) Foreign Application Priority Data
Nov. 8, 2022 (DE) 10 2022 129 394.7

(51) Int. Cl. G01N 21/90; G01N 21/33; G01N 21/84

(52) U.S. Cl. CPC G01N 21/9054; G01N 21/33; G01N 2021/8427; G01N 2021/845

(57) ABSTRACT

An apparatus for inspecting containers, having a transport device which transports the containers along a predefined transport path and an inspection device which inspects a bottom region of the containers, wherein a coating of the bottom region of the containers can be inspected by the inspection device.

### BACKGROUND OF THE INVENTION

The present invention relates to an apparatus and a method for inspecting a bottom region of containers, in particular cans.

It has long been known from the prior art that, in filling lines, the containers to be filled are transported predominantly upright. In the case of cans, the cans are transported predominantly standing on the can bottom. In this case, the sliding properties of the cans play a large role, especially in the wet region.

The sliding properties of cans can generally be characterized by the weight, by the type of the body lacquer (glossy, matte, etc.) or by the bottom lacquer. The transparent bottom lacquer is applied to the annular standing surface of the can and serves the purpose of improving the sliding properties. Missing, deficiently applied or partly chipped bottom lacquer leads to unsteady can motion and can bring about unwanted damage, scratches or fundamentally faulty can handling.

In current filling lines, it is not possible to check the quality of the bottom lacquer. Errors resulting therefrom cannot be unambiguously attributed to the bottom lacquer, and furthermore it is not possible to intervene preventively. Accordingly, settings are changed batch by batch at critical machine parts, for example at the belt agent metering means, in some cases without success.

EP 0 362 679 A2 discloses an apparatus and a method for inspecting cans.

The object of the present invention is therefore to provide an apparatus and a method which make it possible to check the bottom lacquer in particular in the empty-can region upstream of a filling line.

### SUMMARY OF THE INVENTION

An apparatus according to the invention for inspecting containers has a transport device which transports the containers along a predefined transport path. It would be possible for the containers to be transported in a single lane or alternatively on a multi-lane mass conveyor. Furthermore, the apparatus has an inspection device which inspects a bottom region of the containers.

According to the invention, a coating of the bottom region of the containers can be inspected by the inspection device.

It is possible for the inspection device to be arranged in a region of the transport device and/or for the containers to be transported during their transport by means of the transport device. However, it would also be possible for the inspection device to inspect the containers before or after they are transported by means of the transport device.

It would be possible for the inspection device to inspect the containers while they are moving, and it would also be possible for the inspection device to inspect the containers at a standstill, for example while the containers are in a reservoir.

The container is preferably a can and particularly preferably an empty can. It is preferably an open can. The bottom of the can preferably has a coating for improving the sliding properties. Preferably, the coating is applied only to the annular standing surface of the cans. In an advantageous embodiment, the coating is a lacquer and in particular an at least partially transparent lacquer and in particular a completely transparent lacquer which has UV-active particles. The lacquer is in particular transparent or at least partially transparent for light in the visible wavelength range.

The UV-active particles preferably have a fluorescent dye. The fluorescent dye preferably can be excited by UV radiation to emit light in the visible range. The fluorescent dye preferably can be excited by UV radiation having a wavelength of less than 400 nm, preferably less than 350 nm and particularly preferably less than 300 nm.

The UV-active particles preferably have a proportion of fluorescent dye.

The apparatus preferably has a transport device which transports the containers and in particular the cans along a predefined transport path. The containers are preferably transported in such a way that, at least in a section of the transport device, the bottom region of the containers is not contacted or covered by the transport device or by parts of the transport device. The containers are preferably transported while laterally clamped, preferably by two (in particular circumference) conveyor belts.

However, transport by means of suction or by means of a negative pressure would also be possible. The containers could thus be held, for example, by the application of a negative pressure to a predefined region of the container, for example to a can flange.

The apparatus preferably has an inspection device which is suitable and intended for inspecting a bottom region of the containers and particularly preferably for inspecting a coating of the bottom region of the containers. The inspection device is preferably arranged below the transport path of the containers. However, it would also be conceivable for the containers to be turned over for the purpose of inspection. It would also be conceivable for the inspection to be carried out through a transparent support surface on which the containers are transported.

In an advantageous embodiment, the inspection device has a detection device for detecting spatially resolved recordings and preferably recordings of the bottom region of the containers. The detection device preferably has an image-recording device and in particular a camera which is suitable and intended in particular for recording spatially resolved images.

The inspection device preferably has an illumination device for illuminating the containers to be inspected. The illumination device can be a clocked illumination device, which is particularly preferably triggered or synchronized with respect to the recording of images of the containers.

In an advantageous embodiment, the inspection device has at least one UV light source, by which the UV-active particles can be excited to emit fluorescent radiation. The UV light source is preferably a UV LED and particularly preferably an assembly of UV LEDs. The UV LEDs are preferably such which emit UV radiation with a wavelength of 350 nm (or in a wavelength range around 350 nm) and/or particularly preferably such which emit UV radiation with a wavelength of 265 nm (or in a wavelength range around 265 nm).

In a further preferred embodiment, a filter device is provided between the light source and the container. For example, the light source can be designed as a UV-A light source and preferably have a filter device. The filter device can preferably be a filter device centered on a specific wavelength, for example a filter device centered on 365 nm.

In a preferred embodiment, the illumination device or the UV light source is arranged at an angle of less than 60° and preferably less than 50° and particularly preferably less than 40° with respect to the transport path of the containers. In a preferred embodiment, the detection device is arranged at an angle of less than 60° and preferably less than 50° and particularly preferably less than 40° with respect to the transport path of the containers. In a preferred embodiment, the illumination device or the UV light source and the detection device are arranged at an angle of less than 120°, preferably less than 90° and particularly preferably less than 60° with respect to the container to be inspected.

In a further preferred embodiment, the light source is arranged above the container in the vertical direction (in particular at the time of the image recording).

In a preferred embodiment, the illumination device has a power which is between 20 W and 100 W, preferably between 20 W and 80 W and preferably between 30 W and 50 W. Preferably, an emitted light power is between 2 W and 10 W.

In a further preferred embodiment, the light source has an annular emission surface. For example, several LEDs can be arranged annularly.

In an advantageous embodiment, the inspection device has a detection device for detecting data, wherein the data being spatially resolved recordings of the bottom region of the containers and/or being intensities of the emitted fluorescent radiation.

The detection device is preferably suitable and intended both for detecting spatially resolved recordings of the bottom region of the containers and for detecting the intensities of the emitted fluorescent radiation, in particular in a spatially resolved manner. It would also be conceivable for only spatially resolved recordings to be detected.

It is thereby possible to visualize the bottom lacquer by means of UV illumination and preferably to characterize the bottom lacquer by means of suitable camera technology and software technology. Thinner bottom lacquer, bottom lacquer which is patchy or completely absent, and chipped bottom lacquer can be detected and (the corresponding container) can be ejected preventively, so that the line efficiency remains high regardless of the batch quality of the container suppliers and the machine settings remain constant.

Preferably, the detection device has at least one photodiode and preferably a photodiode array and particularly preferably a photomultiplier for detecting the emitted fluorescence radiation. The inspection device, more precisely the detection device, preferably has a monochromator which is characteristic for a wavelength of the emitted fluorescent radiation and/or which allows the radiation incident on the monochromator to be resolved with respect to its wavelengths. The monochromator is preferably adaptable to a wavelength of the emitted fluorescent radiation. This offers the advantage that, when the coating used or the fluorescent dye is changed, the capturing device can be adapted to the fluorescent dye.

In an advantageous embodiment, the inspection device has an evaluation device which is suitable and intended for evaluating the data detected by the detection device. The detected data are preferably the detected spatially resolved recordings and/or the detected intensities of the emitted fluorescent radiation. In an advantageous embodiment, the inspection device has a storage device in which reference data and/or calibration data and/or comparison images are stored. The captured spatially resolved recordings and/or captured intensities of the emitted fluorescent radiation are preferably stored in the storage device.

In a preferred embodiment, the detected data are evaluated using a trained AI. The calibration data and/or reference data are preferably used to train the AI. The AI is preferably configured to assess, on the basis of the detected data, whether the inspected container or the inspected coating meets the specifications. The AI is preferably configured to assign the captured data to specific classes, for example whether a recognized defect is a chipped lacquer, a lacquer application which is insufficient and/or excessive in some regions, a global lacquer application which is too small, and the like.

The storage device can preferably be either a local memory or an external memory. Preferably, the external storage device is a cloud-based storage device and/or an external server, wherein the storage device is accessed in particular via the Internet.

Calibration data which contain a relationship between a detected intensity of the emitted fluorescent radiation and the total amount of fluorescent dye are preferably stored in the storage device. The calibration data are preferably characteristic for a fluorescent dye used, and the calibration data are particularly preferably characteristic for a proportion of the fluorescent dye in the lacquer used for coating.

In an advantageous embodiment, the inspection device can be calibrated and the captured calibration data are preferably stored in the storage device. Preferably, a set of coated containers and preferably several sets of coated containers are used for calibration, wherein the containers within a set differing from one another only by one parameter. Preferably, this parameter is a layer thickness, a total amount of lacquer used, a proportion of the fluorescent dye in the lacquer used, the type of the fluorescence dye used, and the like.

The evaluation device is preferably suitable and intended for determining, by comparing the spatially resolved recordings of the containers to be inspected with reference images stored in the storage device, whether the inspected container corresponds to the (predefined) requirements. Preferably, tolerance limits within which an inspected container still meets the requirements can be specified to the evaluation device.

Preferably, the evaluation device is suitable and intended for allowing the total amount of fluorescent dye to be deduced by evaluation of the detected intensities of the emitted fluorescent radiation. Preferably, if the proportion of the fluorescence dye in the coating is known, a total amount of the coating can be deduced. In a preferred embodiment, it is possible, by means of a combination with the spatially resolved recordings, to determine a (mean) layer thickness of the coating.

The evaluation device is preferably suitable and intended for determining, by comparing the spatially resolved images with the reference images stored in the storage device, whether the coating has faulty regions, for example chipped lacquer points or an uneven application of the lacquer. Preferably, the evaluation device is suitable and intended for determining whether the lacquer was applied only on the intended surface (annular standing region) or whether adjacent regions have likewise been coated. Preferably, the evaluation device is suitable and intended for determining, by evaluation of the intensity data, whether too much or too little lacquer was applied or whether in some regions too much or too little lacquer was applied.

In an advantageous embodiment, the apparatus has an ejection device which is suitable and intended for ejecting the inspected container depending on a result of the evaluation device.

This offers the advantage that faulty containers, in particular cans, can be ejected preventively, whereby the efficiency of a downstream filling device can be increased and the number of operator interventions can be reduced.

In an advantageous embodiment, the inspection device has a cover which is suitable and intended for protecting the surroundings and in particular an operator of the system from the (harmful) UV radiation and preferably for protecting the inspection device from external influences, in particular from light. The inspection device preferably has a safety mechanism, as a result of which UV radiation can be emitted only when the cover is in a closed state. For example, this can be a magnetic switch.

The present invention is also directed to a method for inspecting containers, wherein a transport device is provided which transports the containers along a predefined transport path. Furthermore, an inspection device is provided which inspects a bottom region of the containers, wherein the inspection device having a detection device for detecting data and an evaluation device for evaluating the detected data. According to the invention, the inspection device inspects a coating of the bottom region of the containers.

Preferably, the containers, in particular cans, are transported upright by the transport device, wherein the containers preferably being transported while laterally clamped, so that, at least in a section of the transport device, the bottom region of the containers is not contacted by the transport device or by parts of the transport device. As mentioned above, however, transport or holding of the containers by means of vacuum is also possible. In the case of transport by means of a vacuum transporter, containers are discharged by lateral application of (compressed) air and/or by the switching off of the vacuum for the container to be discharged.

The inspection device is preferably arranged in such a way that the containers and preferably the bottom region of the containers are inspected from below. Preferably, a coating of the bottom surface of the containers which is applied only in the annular standing region of the containers is inspected. In an advantageous method, UV-active particles of the coating are excited by a UV light source of the inspection device to emit fluorescent radiation.

The detection device of the inspection device preferably detects data relating to the coating to be examined. In an advantageous method, the detected data are spatially resolved recordings of the bottom region of the containers and/or are intensities of the emitted fluorescent radiation. Preferably, images are recorded. Preferably, spatially resolved recordings are recorded by a camera. In a preferred method, data relating to the intensity of the emitted fluorescent radiation are captured, preferably by means of a suitable detector, such as a photodiode, a photodiode array, a photomultiplier or the like.

In an advantageous method, the detected data are evaluated by the evaluation device. Preferably, the detected data, in particular the spatially resolved recordings of the coating of the bottom region of the containers, are compared with reference data within the scope of the evaluation, which reference data are stored in a storage device. By means of this comparison, it is determined whether the inspected container, more precisely the coating of the bottom region, meets the requirements.

If an inspected container does not meet the requirements, it can be ejected by an ejection device. Preferably, the captured data are stored in the storage device and are available for a later evaluation. For example, it can be determined whether a certain error, such as a chipped coating, a patchy application of the coating, or an excessively thin coating, is a problem of individual containers or whether it is a batch-wide problem.

In a preferred method, the detected data also comprise, in addition to the spatially resolved recordings of the bottom region, data relating to the intensities of the emitted fluorescent radiation. Preferably, the intensity data are likewise spatially resolved and enable an evaluation of an intensity distribution. For example, regions with a lower intensity of the emitted fluorescent radiation, correlating with a smaller amount of fluorescent dye, can be determined. This corresponds, for example, to a smaller layer thickness in this region. If, for example, lower intensities of the emitted fluorescent radiation are detected in the entire recording region, this could be an indication that the application of the coating is insufficient over the full area, or it could correlate with a lower proportion of fluorescent dye in the coating while, however, a sufficient layer thickness of the lacquer is present. In such a case, an operator of the system can be notified, for example.

Further advantages and embodiments result from the accompanying drawings.

### BRIEF DESCRIPTION OF THE DRAWINGS

In the figures:

FIG. 1 shows a container with an intact coating of the bottom region;

FIG. 2 shows a container with a region having a chipped coating of the bottom region;

FIG. 3 shows a container with a deficient/patchy application of the coating;

FIG. 4 shows a container with a thin application of the coating or an application with a lacquer having a lower proportion of UV-active particles; and

FIG. 5 shows a schematic representation of an apparatus according to the invention.

### DETAILED DESCRIPTION OF THE INVENTION

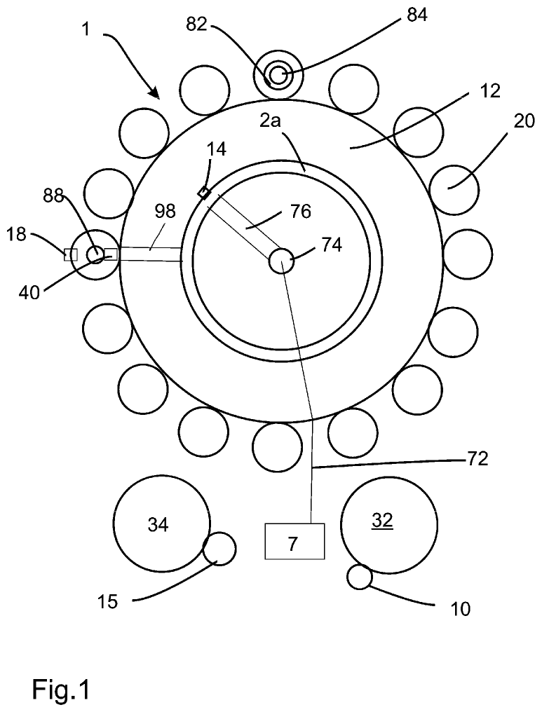

The inspected containers shown in FIGS. 1 to 4 were all illuminated with UV light of identical power.

FIG. 1 shows a container 10, more precisely a can, which has an intact coating 20 with uniform lacquer application in the bottom region 12. In the case of this can, it would be possible for it to be decided whether this can still satisfies the specified parameters, or whether this can is to be ejected from production.

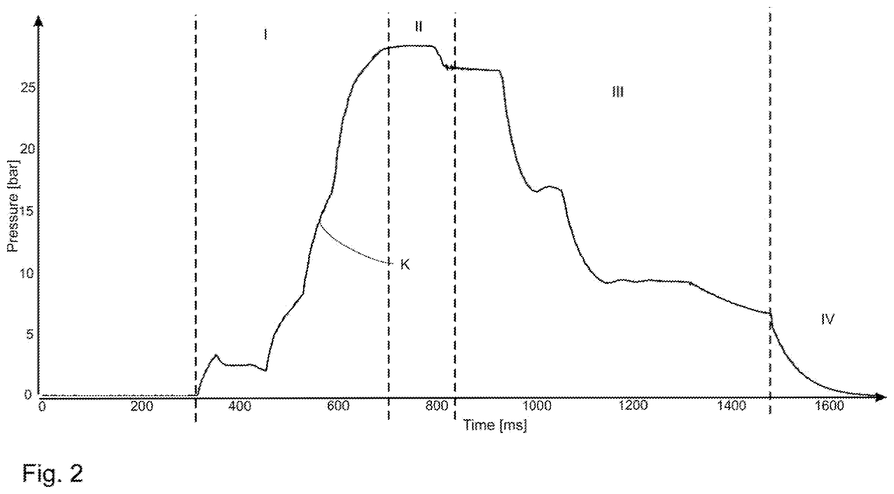

FIG. 2 shows a container which has, in the marked region 22, a chipped region of the coating. Such a container 10 can be identified as faulty by the evaluation device (not shown) and the ejection of the container can be initiated.

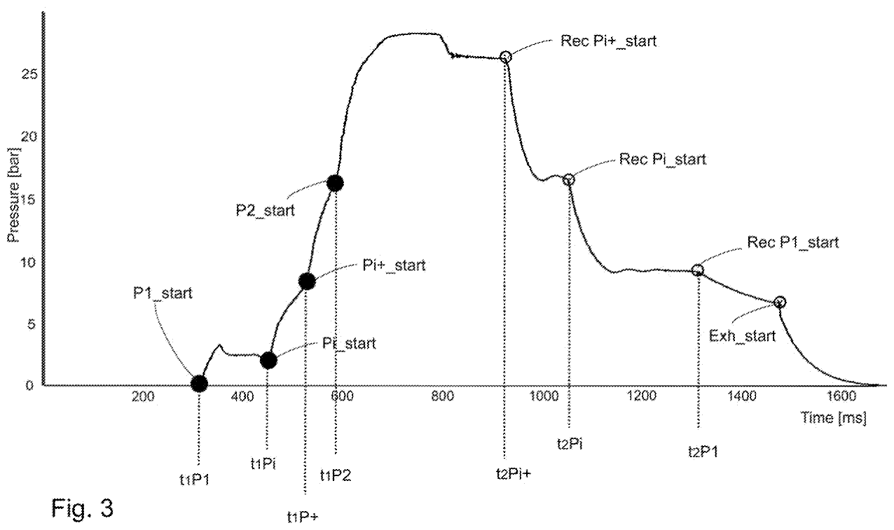

FIG. 3 shows an example of a container 10 on which the lacquer application is patchy or is deficient is some locations. The bottom region has regions with an intact lacquer application (region 20) and regions with an insufficient amount of applied lacquer (region 24). Such a container 10 can be identified as faulty by the evaluation device on the basis of the detected spatially resolved recording and the ejection of the container can be initiated.

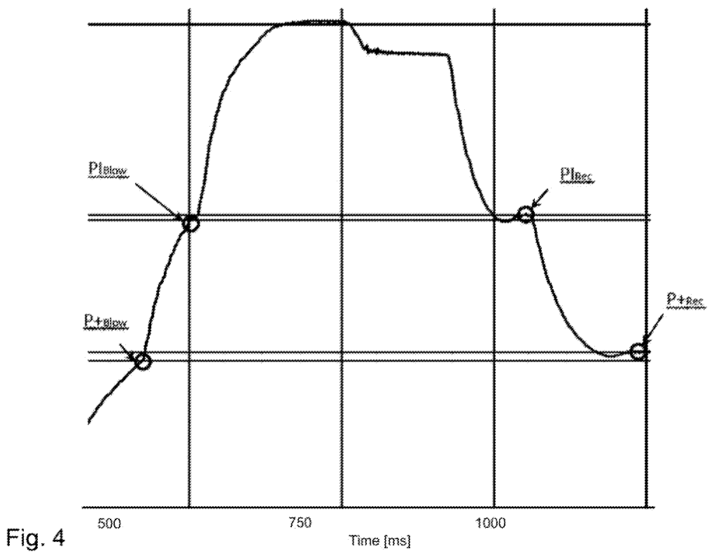

FIG. 4 shows a container 10 on which an overall only weakly fluorescent coating 26 is present. This can either be attributed to an insufficient layer thickness or indicate a lower proportion of fluorescent particles in the lacquer. In this case, it is conceivable that the evaluation device informs an operator of the system.

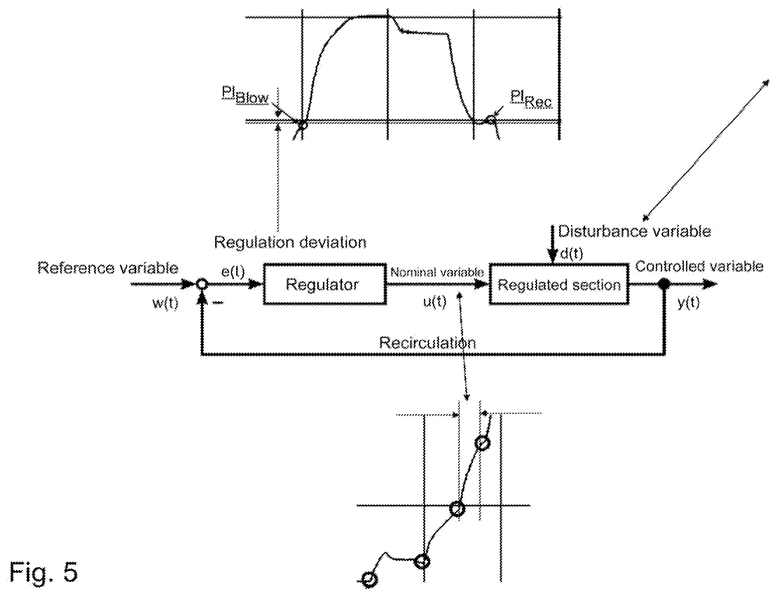

FIG. 5 shows a schematic representation of an apparatus according to the invention. A container is shown here which is illuminated by an illumination device 1 and in particular a UV illumination device. More precisely, the bottom region of the containers is inspected. The reference sign 3 indicates a detection device which preferably records at least one (spatially resolved) image of the transported containers.

The containers are preferably transported past the inspection device 1, 3 along a predefined preferably straight transport path by means of a transport device (not shown).

The reference sign 5 indicates an angle (relative to a vertical direction) at which the illumination device radiates radiation onto the container and in particular onto the bottom region 12 of the bottom. This angle is preferably between 0° and 50°, preferably between 0° and 30° a nd particularly preferably between 0° and 20°. However, it would also be possible for this angle to be 0°.

The reference sign 4 indicates an angle (relative to a vertical direction) at which the detection device observes the container and in particular the bottom region 12 of the bottom. This angle is preferably between 0° and 60°, preferably between 0° and 50° and particularly preferably between 0° and 40°, preferably between 0° and 30°. However, it would al so be possible for this angle to be between 0° and 10° or to be 0°.

In contrast to the embodiment shown in FIG. 5, however, it would also be possible for the detection device 3 to be arranged perpendicularly above the container and/or for the illumination device to be arranged annularly around this detection device. For example, a plurality of light sources, for example UV LEDs, can be concentrically arranged annularly around the detection device.

It is preferably ensured that UV radiation emitted from these LEDs does not reach the detection device directly, but rather first reaches the container or its bottom.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

### LIST OF REFERENCE SIGNS

1 UV light source
3 detection device
4 angle between radiating direction and vertical direction
5 angle between observation direction and vertical direction
10 container (can)
12 bottom region of the container (can)
20 intact coating
22 chipped coating
24 deficient/patchy application of the coating
26 thin application of the coating

1. An apparatus for inspecting containers, having a transport device configured to transport the containers along a predefined transport path and an inspection device configured to inspect a bottom region of the containers,
wherein
a coating of the bottom region of the containers can be inspected by the inspection device.

2. The apparatus according to claim 1,
wherein
the coating is a lacquer which has UV-active particles.

3. The apparatus according to claim 1,
wherein
the inspection device has at least one UV light source, by which the UV-active particles of the coating can be excited to emit fluorescent radiation.

4. The apparatus according to claim 1,
wherein
the inspection device is arranged such that the containers can be inspected during their transport by the transport device and during their transport movement.

5. The apparatus according to claim 1,
wherein
the inspection device has a detection device configured for detecting data, wherein the data being spatially resolved recordings of the bottom region of the containers and/or being intensities of the emitted fluorescent radiation.

6. The apparatus according to claim 1,
wherein
the inspection device has an evaluation device which is configured for evaluating the data captured by the detection device.

7. The apparatus according to claim 6,
wherein
the apparatus has an ejection device which is configured for ejecting the inspected container depending on a result of the evaluation device.

8. A method for inspecting containers on a transport device which transports the containers along a predefined transport path and with an inspection device which inspects a bottom region of the containers, wherein the inspection device has a detection device for detecting data and an evaluation device for evaluating the detected data,
characterized in that
the inspection device inspects a coating of the bottom region of the containers.

9. The method according to claim 8,
wherein
UV-active particles of the coating are excited by a UV light source of the inspection device to emit fluorescent radiation.

10. The method according to claim 9,
wherein
the detected data are spatially resolved recordings of the bottom region of the containers and/or is intensities of the emitted fluorescent radiation and/or images are recorded.

11. The method according to claim 10,
wherein
the detected data are evaluated by the evaluation device.
